(19) United States
(12) Patent Application Publication
(10) Pub. No.: US 2023/0183538 A1
(43) Pub. Date: Jun. 15, 2023

(54) Stabilized Heat Transfer Fluid Compositions

(71) Applicant: THE CHEMOURS COMPANY FC, LLC, WILMINGTON, DE (US)

(72) Inventors: RAYMOND WU, MOUNT LAUREL, NJ (US); MICHAEL R. FRASER, QUAKERTOWN, PA (US)

(73) Assignee: THE CHEMOURS COMPANY FC, LLC, WILMINGTON, DE (US)

(21) Appl. No.: 17/925,481

(22) PCT Filed: May 14, 2021
(86) PCT No.: PCT/US2021/032367

§ 371 Date: Nov. 15, 2022

Related U.S. Application Data
(60) Provisional application No. 63/027,088, filed on May 19, 2020.

(51) Int. Cl. C09K 5/04; C11D 7/50; C11D 7/26; C11D 7/32; C10M 105/52; F25B 13/00

(52) U.S. Cl. CPC C09K 5/045; C11D 7/5018; C11D 7/264; C11D 7/266; C11D 7/267; C11D 7/261; C11D 7/32; C10M 105/52; F25B 13/00; C09K 2205/24; C09K 2205/112; C10M 2211/0206; C10N 2050/02

(57) ABSTRACT

The present application provides stabilized compositions (e.g., stabilized heat transfer fluids) comprising methyl perfluoroheptene for use, for example, in refrigeration and heat transfer applications. The stabilized compositions of the present invention are useful in methods for producing cooling and heating, methods for replacing refrigerants and refrigeration, air conditioning, heat pump apparatuses, and as solvents or dewatering agents.

### TECHNICAL FIELD

The present application relates to stabilized compositions (e.g., stabilized heat transfer fluids) comprising methyl perfluoroheptene ether for use in refrigeration and heat transfer applications. The stabilized compositions of the present invention exhibit reduced degradation compared to methyl perfluoroheptene ether and are useful in methods for producing cooling and heating, methods for replacing refrigerants and refrigeration, air conditioning, and heat pump apparatuses.

### BACKGROUND

Many of today's semiconductor manufacturing processes, power electronics, power avionics and computing data center desires an advanced, environmental sustainable, safe, nonflammable, nonconductive, noncorrosive and thermally stable heat transfer fluid to maintain its optimum performance over an extended period of time. Perfluorocarbons (PFCs) have been successful and widely used in heat transfer applications due to their combinations of good safety and health attributes, dielectric properties, and thermal stability properties. However, PFC's atmospheric lifetimes range from few hundred years to over 10,000 years and are powerful greenhouse gases with global warming potentials (GWPs) reaching greater than 8,600 (100-yr ITH). Recent environmental concerns and government regulations have focused on mitigating global warming.

### SUMMARY

The present application provides, inter alia, compositions comprising:
i) methyl perfluoroheptene ether; and
ii) a second component selected from the group consisting of butylated hydroxy toluene (BHT), hydroquinone monomethyl ether (HQMME), 2-tert-butyl-6-methylphenol, 2-tert-butyl-5-methylphenol and 2-tert-butyl-4-ethylphenol, 1,3-dioxolane, 1,2-epoxybutane, and nitromethane, or any mixture thereof.

The present application further provides methods of reducing acidic degradation of a working fluid comprising methyl perfluoroheptene ether, comprising mixing the working fluid with a second component selected from the group consisting of one or more antioxidants and one or more acid scavengers, or any mixture thereof, thereby forming a stabilized working fluid provided herein.

The present application further provides processes for dissolving a solute, comprising contacting and mixing said solute with a sufficient quantity of a composition provided herein.

The present application further provides processes of cleaning a surface, comprising contacting a composition provided herein with said surface.

The present application further provides processes for removing at least a portion of water from the surface of a wetted substrate, comprising contacting the substrate with a composition provided herein, and then removing the substrate from contact with the composition.

The present application further provides processes of depositing a fluorolubricant on a surface, comprising:
a) combining a fluorolubricant and a solvent to form a lubricant-solvent combination, wherein the solvent comprises a composition provided herein;
b) contacting the lubricant-solvent combination with the surface; and
c) evaporating the solvent from the surface to form a fluorolubricant coating on the surface.

The present application further provides processes for producing cooling, comprising condensing a composition provided herein and thereafter evaporating said composition in the vicinity of a body to be cooled.

The present application further provides processes for producing heating, comprising evaporating a composition provided herein and thereafter condensing said composition in the vicinity of a body to be heated.

The present application further provides methods for producing cooling, comprising circulating a heat transfer fluid comprising a composition provided herein in the vicinity of a body to be cooled, wherein the heat transfer fluid is a working fluid that removes heat from, adds heat to, or maintains temperature of the vicinity of the body to be cooled.

The present application further provides methods of replacing heat transfer fluid in a cooling fluid distribution unit, a refrigeration system, or a heat pump system, comprising providing a composition provided herein as replacement for said heat transfer fluid.

### DESCRIPTION OF DRAWINGS

FIG. 1 shows results of a total acid number (TAN) analysis of representative compositions of the invention at 75° C.

FIG. 2 shows results of a total acid number (TAN) analysis of representative compositions of the invention at 90° C.

FIG. 3 shows results of a total acid number (TAN) analysis of representative compositions of the invention at 100° C.

FIG. 4 shows a comparative total acid number (TAN) analysis conducted at 75° C. over 6 days.

### DETAILED DESCRIPTION

Methylperfluoroheptene ether (MPHE) is a hydrofluoroolefin (HFO) based fluorinated fluid with a low GPW of 2.5 (100-yr ITH) and zero ODP. MPHE exhibit an application profile similar to PFCs but with a significantly lower GPW. However, a consequence of the low GWP is that the functionality may also be susceptible to hydrolysis and other form of degradations. Measurable acidity in the MPHE has been observed to be higher than its product specification at elevated temperatures and prolonged storage at room temperature. The acidity formation to the fluid at these conditions may lead to reduced shelf-life and can potentially damage equipment without appropriate mitigation. Accordingly, the present application provides stabilized compositions that exhibited reduced degradation over time and elevated temperatures, compared to MPHE.

### Compositions

The present application provides compositions, comprising methyl perfluoroheptene ether (MPHE) and a second component selected from the group consisting of one or more antioxidants and one or more acid scavengers, or any mixture thereof.

In some embodiments, the one or more acid antioxidants are selected from butylated hydroxy toluene (BHT), hydroquinone monomethyl ether (HQMME), 2-tert-butyl-6-methylphenol, 2-tert-butyl-5-methylphenol and 2-tert-butyl-4-ethylphenol.

In some embodiments, the one or more scavengers are selected from 1,3-dioxolane, 1,2-epoxybutane and nitromethane.

In some embodiments, the composition comprises methyl perfluoroheptene ether and a second component selected from one or more antioxidants. In some embodiments, the composition comprises methyl perfluoroheptene ether and a second component selected from one or two antioxidants.

In some embodiments, the composition comprises methyl perfluoroheptene ether and a second component selected from one or more acid scavengers. In some embodiments, the composition comprises methyl perfluoroheptene ether and a second component selected from one or two acid scavengers.

In some embodiments, the composition comprises methyl perfluoroheptene ether and a second component selected from a mixture of one or more antioxidants and one or more acid scavengers. In some embodiments, the composition comprises methyl perfluoroheptene ether and a second component selected from a mixture of one or two antioxidants and one or two acid scavengers. In some embodiments, the composition comprises methyl perfluoroheptene ether and a second component selected from a mixture of one antioxidant and one acid scavenger.

In some embodiments, the compositions provided herein comprise:
i) methyl perfluoroheptene ether; and
ii) a second component selected from the group consisting of butylated hydroxy toluene, hydroquinone monomethyl ether, 2-tert-butyl-6-methylphenol, 2-tert-butyl-5-methylphenol and 2-tert-butyl-4-ethylphenol 1,3-dioxolane, 1,2-epoxybutane and nitromethane, or any mixture thereof.

In some embodiments, the compositions provided herein consist essentially of:
i) methyl perfluoroheptene ether; and
ii) a second component selected from the group consisting of butylated hydroxy toluene, hydroquinone monomethyl ether, 2-tert-butyl-6-methylphenol, 2-tert-butyl-5-methylphenol and 2-tert-butyl-4-ethylphenol 1,3-dioxolane, 1,2-epoxybutane and nitromethane, or any mixture thereof.

In some embodiments, the compositions provided herein consist of:
i) methyl perfluoroheptene ether; and
ii) a second component selected from the group consisting of butylated hydroxy toluene, hydroquinone monomethyl ether, 2-tert-butyl-6-methylphenol, 2-tert-butyl-5-methylphenol and 2-tert-butyl-4-ethylphenol 1,3-dioxolane, 1,2-epoxybutane and nitromethane, or any mixture thereof.

In some embodiments, the second component is present in the composition in an amount effective to maintain a total acid number of the composition at about 0.2 mg KOH/g, or less, for example, about 0.1 mg KOH/g or less, about 0.075 mg KOH/g or less, about 0.050 mg KOH/g or less, about 0.025 mg KOH/g or less, or about 0.01 mg KOH/g or less. In some embodiments, the second component is present in the composition in an amount effective to maintain a total acid number of the composition at about 0.1 mg KOH/g, or less.

In some embodiments, the second component is present in the composition in an amount effective to maintain a total acid number of the composition at about 0.01 mg KOH/g to about 0.2 mg KOH/g, for example, about 0.01 mg KOH/g to about 0.15 mg KOH/g, about 0.01 mg KOH/g to about 0.1 mg KOH/g, about 0.01 mg KOH/g to about 0.075 mg KOH/g, about 0.01 mg KOH/g to about 0.050 mg KOH/g, about 0.01 mg KOH/g to about 0.025 mg KOH/g, about 0.025 mg KOH/g to about 0.2 mg KOH/g, about 0.025 mg KOH/g to about 0.15 mg KOH/g, about 0.025 mg KOH/g to about 0.1 mg KOH/g, about 0.025 mg KOH/g to about 0.075 mg KOH/g, about 0.025 mg KOH/g to about 0.050 mg KOH/g, about 0.050 mg KOH/g to about 0.2 mg KOH/g, about 0.050 mg KOH/g to about 0.15 mg KOH/g, about 0.050 mg KOH/g to about 0.1 mg KOH/g, about 0.050 mg KOH/g to about 0.075 mg KOH/g, about 0.075 mg KOH/g to about 0.2 mg KOH/g, about 0.075 mg KOH/g to about 0.15 mg KOH/g, about 0.075 mg KOH/g to about 0.1 mg KOH/g, about 0.1 mg KOH/g to about 0.2 mg KOH/g, about 0.1 mg KOH/g to about 0.15 mg KOH/g, or about 0.15 mg KOH/g to about 0.2 mg KOH/g. In some embodiments, the second component is present in the composition in an amount effective to maintain a total acid number of the composition at about 0.01 mg KOH/g to about 0.1 mg KOH/g. In some embodiments, the second component is present in the composition in an amount effective to maintain a total acid number of the composition at about 0.1 mg KOH/g.

In some embodiments, the methyl perfluoroheptene ether comprises a mixture of about 48 to about 52 weight percent 5-methoxy perfluoro-3-heptene, about 18 to about 22 weight percent 3-methoxy perfluoro-3-heptene, about 18 to about 22 weight percent 4-methoxy perfluoro-2-heptene, and about 6 to about 10 weight percent 4-methoxy perfluoro-3-heptene.

In some embodiments, the methyl perfluoroheptene ether comprises a mixture of about 50 weight percent 5-methoxy perfluoro-3-heptene, about 20 weight percent 3-methoxy perfluoro-3-heptene, about 20 weight percent 4-methoxy perfluoro-2-heptene, and about 8 weight percent 4-methoxy perfluoro-3-heptene.

In some embodiments, the methyl perfluoroheptene ether comprises a mixture of about 48 to about 52 weight percent 5-methoxy (E)-perfluoro-3-heptene, about 12 to about 16 weight percent 3-methoxy (E)-perfluoro-3-heptene, about 4 to about 8 weight percent 3-methoxy (Z)-perfluoro-3-heptene, about 18 to about 22 weight percent 4-methoxy (E)-perfluoro-2-heptene, about 1 to about 3 weight percent 4-methoxy (Z)-perfluoro-3-heptene, and about 4 to about 8 weight percent 4-methoxy (E)-perfluoro-3-heptene.

In some embodiments, the methyl perfluoroheptene ether comprises a mixture of about 50 weight percent 5-methoxy (E)-perfluoro-3-heptene, about 14 weight percent 3-methoxy (E)-perfluoro-3-heptene, about 6 weight percent 3-methoxy (Z)-perfluoro-3-heptene, about 20 weight percent 4-methoxy (E)-perfluoro-2-heptene, about 2 weight percent 4-methoxy (Z)-perfluoro-3-heptene, and about 6 weight percent 4-methoxy (E)-perfluoro-3-heptene.

In some embodiments, the second component is selected from the group consisting of 1,3-dioxolane, butylated hydroxy toluene and hydroquinone monomethyl ether. In some embodiments, the second component is selected from the group consisting of butylated hydroxy toluene and hydroquinone monomethyl ether.

In some embodiments, the second component is selected from the group consisting of:
butylated hydroxy toluene;
hydroquinone monomethyl ether;
2-tert-butyl-6-methylphenol;
2-tert-butyl-5-methylphenol;
2-tert-butyl-4-ethylphenol;
a mixture of butylated hydroxy toluene and 1,2-epoxybutane;
a mixture of hydroquinone monomethyl ether and 1,3-dioxolane;
a mixture of hydroquinone monomethyl ether and 1,2-epoxybutane;
a mixture of 2-tert-butyl-6-methylphenol and 1,2-epoxybutane;
a mixture of 2-tert-butyl-6-methylphenol and nitromethane and
a mixture of butylated hydroxy toluene and 1,3-dioxolane.

In some embodiments, the composition comprises about 100 ppm to about 1100 ppm of the second component, for example, about 100 ppm to about 1000 ppm, about 100 ppm to about 900 ppm, about 100 ppm to about 800 ppm, about 100 ppm to about 700 ppm, about 100 ppm to about 600 ppm, about 100 ppm to about 500 ppm, about 100 ppm to about 400 ppm, about 100 ppm to about 300 ppm, about 100 ppm to about 200 ppm, about 200 ppm to about 1100 ppm, about 200 ppm to about 1000 ppm, about 200 ppm to about 900 ppm, about 200 ppm to about 800 ppm, about 200 ppm to about 700 ppm, about 200 ppm to about 600 ppm, about 200 ppm to about 500 ppm, about 200 ppm to about 400 ppm, about 200 ppm to about 300 ppm, about 300 ppm to about 1100 ppm, about 300 ppm to about 1000 ppm, about 300 ppm to about 900 ppm, about 300 ppm to about 800 ppm, about 300 ppm to about 700 ppm, about 300 ppm to about 600 ppm, about 300 ppm to about 500 ppm, about 300 ppm to about 400 ppm, about 400 ppm to about 1100 ppm, about 400 ppm to about 1000 ppm, about 400 ppm to about 900 ppm, about 400 ppm to about 800 ppm, about 400 ppm to about 700 ppm, about 400 ppm to about 600 ppm, about 400 ppm to about 500 ppm, about 500 ppm to about 1100 ppm, about 500 ppm to about 1000 ppm, about 500 ppm to about 900 ppm, about 500 ppm to about 800 ppm, about 500 ppm to about 700 ppm, about 500 ppm to about 600 ppm, about 600 ppm to about 1100 ppm, about 600 ppm to about 1000 ppm, about 600 ppm to about 900 ppm, about 600 ppm to about 800 ppm, about 600 ppm to about 700 ppm, about 700 ppm to about 1100 ppm, about 700 ppm to about 1000 ppm, about 700 ppm to about 900 ppm, about 700 ppm to about 800 ppm, about 800 ppm to about 1100 ppm, about 800 ppm to about 1000 ppm, about 800 ppm to about 900 ppm, about 900 ppm to about 1100 ppm, about 900 ppm to about 1000 ppm, or about 1000 ppm to about 1100 ppm. In some embodiments, the composition comprises about 100 ppm to about 1100 ppm of the second component.

In some embodiments, the composition comprises about 100 ppm to about 550 ppm of the second component, for example, about 100 ppm to about 500 ppm, about 100 ppm to about 400 ppm, about 100 ppm to about 300 ppm, about 100 ppm to about 200 ppm, about 200 ppm to about 550 ppm, about 200 ppm to about 500 ppm, about 200 ppm to about 400 ppm, about 200 ppm to about 300 ppm, about 300 ppm to about 550 ppm, about 300 ppm to about 500 ppm, about 300 ppm to about 400 ppm, about 400 ppm to about 550 ppm, about 400 ppm to about 500 ppm, or about 500 ppm to about 550 ppm. In some embodiments, the composition comprises about 100 ppm to about 550 ppm of the second component. In some embodiments, the composition comprises about 140 ppm to about 500 ppm of the second component.

In some embodiments, the composition comprises about 0.01 wt % to about 0.15 wt % of the second component, for example, about 0.01 wt % to about 0.011 wt %, about 0.01 wt % to about 0.01 wt %, about 0.01 wt % to about 0.075 wt %, about 0.01 wt % to about 0.050 wt %, about 0.01 wt % to about 0.025 wt %, about 0.025 wt % to about 0.15 wt %, about 0.025 wt % to about 0.11 wt %, about 0.025 wt % to about 0.1 wt %, about 0.025 wt % to about 0.075 wt %, about 0.025 wt % to about 0.050 wt %, about 0.050 wt % to about 0.15 wt %, about 0.050 wt % to about 0.11 wt %, about 0.050 wt % to about 0.1 wt %, about 0.050 wt % to about 0.075 wt %, about 0.075 wt % to about 0.1 wt %, about 0.075 wt % to about 0.15 wt %, about 0.075 wt % to about 0.11 wt %, about 0.075 wt % to about 0.1 wt %, about 0.1 wt % to about 0.15 wt %, about 0.1 wt % to about 0.11 wt %, or about 0.11 wt % to about 0.15 wt %. In some embodiments, the composition comprises about 0.01 wt % to about 0.11 wt % of the second component. In some embodiments, the composition comprises about 0.01 wt % to about 0.05 wt % of the second component. In some embodiments, the composition comprises about 0.01 wt % to about 0.045 wt % of the second component. In some embodiments, the composition comprises about 0.01 wt % to about 0.11 wt % of the second component.

In some embodiments, the composition comprises methyl perfluoroheptene ether; and
about 450 ppm to about 550 ppm butylated hydroxy toluene; or
about 100 ppm to about 200 ppm hydroquinone monomethyl ether; or
about 400 ppm to about 550 ppm butylated hydroxy toluene and about 450 ppm to about 550 ppm 1,2-epoxybutane; or
about 100 ppm to about 200 ppm hydroquinone monomethyl ether and about 450 ppm to about 550 ppm 1,3-dioxolane; or
about 100 ppm to about 200 ppm hydroquinone monomethyl ether and about 450 ppm to about 550 ppm 1,2-epoxybutane; or
about 450 ppm to about 550 ppm butylated hydroxy toluene and about 450 ppm to about 550 ppm 1,3-dioxolane; or
about 50 to about 500 ppm 2-tert-butyl-6-methylphenol; or
about 50 to about 500 ppm 2-tert-butyl-5-methylphenol; or
about 50 to about 500 ppm 2-tert-butyl-4-ethylphenol; or
about 50 to about 500 ppm 2-tert-butyl-6-methylphenol and about 200 to about 600 ppm 1,2-epoxybutane; or
about 50 to about 500 ppm 2-tert-butyl-6-methylphenol and about 200 to about 600 ppm nitromethane; or
about 300 ppm 2-tert-butyl-6-methylphenol; or
about 300 ppm 2-tert-butyl-5-methylphenol; or
about 300 ppm 2-tert-butyl-4-ethylphenol; or
about 300 ppm 2-tert-butyl-6-methylphenol and about 400 ppm 1,2-epoxybutane; or
about 300 ppm 2-tert-butyl-6-methylphenol and about 400 ppm nitromethane.
In some embodiments, the composition comprises methyl perfluoroheptene ether; and
about 140 ppm hydroquinone monomethyl ether; or
about 500 ppm butylated hydroxy toluene; or
about 140 ppm hydroquinone monomethyl ether and about 500 ppm 1,2-epoxybutane; or
about 500 ppm butylated hydroxy toluene and about 500 ppm 1,2-epoxybutane; or
about 500 ppm butylated hydroxy toluene and about 500 ppm 1,3-dioxolane
about 140 ppm hydroquinone monomethyl ether and about 500 ppm 1,3-dioxolane; or
about 450 ppm butylated hydroxy toluene and about 500 ppm 1,2-epoxybutane

### Methods of Use

The present application provides methods of reducing acidic degradation of a working fluid comprising methyl perfluoroheptene ether. In some embodiments, the methods comprise mixing the working fluid with a second component selected from the group consisting of one or more antioxidants and one or more acid scavengers, or any mixture thereof, thereby forming a stabilized working fluid.

In some embodiments, the method comprises reducing the total acid number (TAN) of the working fluid, compared to the unstabilized working fluid (e.g., a composition comprising methyl perfluoroheptene ether in the absence of the one or more antioxidants and one or more acid scavengers, or any mixture thereof).

In some embodiments, the method comprises reducing the total acid number (TAN) of the working fluid at a temperature greater than about 50° C., for example, greater than about 50° C., greater than about 60° C., greater than about 70° C., greater than about 80° C., greater than about 90° C., or greater than about 100° C., compared to the unstabilized working fluid (e.g., a composition comprising methyl perfluoroheptene ether in the absence of the one or more antioxidants and one or more acid scavengers, or any mixture thereof).

In some embodiments, the present application provides methods of improving the stability of a working fluid comprising methyl perfluoroheptene ether.

In some embodiments, the present application provides methods of improving the stability of a working fluid comprising methyl perfluoroheptene ether at a temperature greater than about 50° C., greater than about 50° C., greater than about 60° C., greater than about 70° C., greater than about 80° C., greater than about 90° C., or greater than about 100° C.

In some embodiments, the present application provides methods of improving the stability of a working fluid comprising methyl perfluoroheptene ether at a temperature greater than about 50° C. over a time period of from about 1 day to about 12 months, for example, about 1 day about 6 months, about 1 day about 5 months, about 1 day about 4 months, about 1 day about 3 months, about 1 day about 2 months, about 1 day about 1 months, about 1 month to about 12 months, about 1 month to about 6 months, about 1 month to about 5 months, about 1 month to about 4 months, about 1 month to about 3 months, about 1 month to about 2 months, about 2 months to about 12 months, about 2 months to about 6 months, about 2 months to about 5 months, about 2 months to about 4 months, about 2 months to about 3 months, about 3 months to about 12 months, about 3 months to about 6 months, about 3 months to about 5 months, about 3 months to about 4 months, about 4 months to about 12 months, about 4 months to about 6 months, about 4 months to about 5 months, about 5 months to about 12 months, about 5 months to about 6 months, or about 6 months to about 12 months.

The compositions provided herein can act as a working fluid used to carry heat from a heat source to a heat sink. Such heat transfer compositions may also be useful as a refrigerant in a cycle wherein the fluid undergoes a phase change; that is, from a liquid to a gas and back, or vice versa, or as a single phase working fluid (e.g., as a chiller heat transfer fluid (HFT) or circulating fluid). Examples of heat transfer systems include but are not limited to air conditioners, freezers, refrigerators, heat pumps, water chillers, flooded evaporator chillers, direct expansion chillers, walk-in coolers, high temperature heat pumps, mobile refrigerators, mobile air conditioning units, immersion cooling systems, data-center cooling systems, and combinations thereof. It is understood that the exemplary heat transfer systems can comprise components useful for single phase heat transfer. Accordingly, the present application provides heat transfer systems (e.g., a heat transfer apparatus) as described herein, comprising a composition provided herein. In some embodiments, the composition provided herein is useful as a working fluid or heat transfer fluid (e.g., a working fluid for refrigeration or heating applications) in the heat transfer system. In some embodiments, the compositions provided herein are useful in an apparatus or system comprising a high temperature heat pump (e.g., a heat pump comprising a heat exchanger operating at a temperature greater than about 50° C.). In some embodiments, the high temperature heat pump comprises a centrifugal compressor. In some embodiments, the compositions provided herein are useful in an apparatus or system comprising a chiller apparatus. In some embodiments, the compositions provided herein are useful in an apparatus or system comprising a centrifugal chiller apparatus. In some embodiments, the compositions provided herein are useful in a centrifugal high temperature heat pump.

In some embodiments, the compositions provided may be useful as a heat transfer fluid (e.g., a chiller heat transfer fluid or circulating fluid). As used herein, a heat transfer fluid (HFT), or circulating fluid, is a working fluid that can remove heat, add heat, or maintain a temperature through in the vicinity of a body to be cooled (e.g., a chiller's refrigeration circuits). In exemplary heat transfer systems, a pumping system circulates cool heat transfer fluid from the chiller to the process (or, e.g., semiconductor manufacturing tools). The heat transfer fluid removes heat from the process and the warmed heat transfer fluid returns to the chiller's tank via a heat exchanger. The heat transfer fluid is re-cooled at the heat exchanger and circulated back to the process side where it will again acquire heat. The process requires temperature control and the circulating fluid is required to be remain in a single phase over the entire process temperature range. In systems using a single phase heat transfer fluid, the properties of the fluid (e.g., viscosity, boiling point, and the like), must remain relatively constant. In some embodiments, the compositions provided herein are useful as heat transfer fluids, wherein the composition maintains a single phase (e.g., liquid) over the operating temperature range of the heat transfer system (e.g., about −140° C. to about 120° C.).

Mechanical vapor-compression refrigeration, air conditioning and heat pump systems include an evaporator, a compressor, a condenser, and an expansion device. A refrigeration cycle re-uses refrigerant in multiple steps producing a cooling effect in one step and a heating effect in a different step. A multiphase cycle (e.g., condensation/evaporation) can be described as follows: Liquid refrigerant enters an evaporator through an expansion device, and the liquid refrigerant boils in the evaporator, by withdrawing heat from the environment, at a low temperature to form a gas and produce cooling. Often air or a heat transfer fluid flows over or around the evaporator to transfer the cooling effect caused by the evaporation of the refrigerant in the evaporator to a body to be cooled. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

A body to be cooled or heated may be defined as any space, location, object or body for which it is desirable to provide cooling or heating. Examples include spaces (open or enclosed) requiring air conditioning, cooling, or heating, such as a room, an apartment, or building, such as an apartment building, university dormitory, townhouse, or other attached house or single-family home, hospitals, office buildings, supermarkets, college or university classrooms or administration buildings and automobile or truck passenger compartments. Additionally, a body to be cooled may include electronic devices, such as computer equipment, central processing units (cpu), data-centers, server banks, and personal computers among others.

By “in the vicinity of” is meant that the evaporator of the system containing the refrigerant is located either within or adjacent to the body to be cooled, such that air moving over the evaporator would move into or around the body to be cooled. In the process for producing heating, “in the vicinity of” means that the condenser of the system containing the refrigerant is located either within or adjacent to the body to be heated, such that the air moving over the evaporator would move into or around the body to be heated. In some embodiments, for heat transfer, “in the vicinity of” may mean that the body to be cooled is immersed directly in the heat transfer composition or tubes containing heat transfer compositions run into around internally, and out of electronic equipment, for instance.

Exemplary refrigeration systems include, but are not limited to, equipment including commercial, industrial or residential refrigerators and freezers, ice machines, self-contained coolers and freezers, vending machines, flooded evaporator chillers, direct expansion chillers, water chiller, centrifugal chillers, walk-in and reach-in coolers and freezers, and combination systems. In some embodiments, the compositions provided herein may be used in supermarket refrigeration systems. Additionally, stationary applications may utilize a secondary loop system that uses a primary refrigerant to produce cooling in one location that is transferred to a remote location via a secondary heat transfer fluid.

In some embodiments, the compositions provided herein are useful in single phase chiller systems (e.g., a chiller capable of operating using a single-phase heat transfer composition). In some embodiments, the single-phase chiller system comprises a single-phase semi-conductor chiller. In some embodiments, the compositions provided herein are useful over a wide range of temperatures for cooling and heating applications. For example, the compositions provided herein may be suitable as a working fluid at a temperature of from about −140° C. to about 120° C., for example, about −140° C. to about 110° C., about −140° C. to about 100° C., about −140° C. to about 50° C., about −140° C. to about 25° C., about −140° C. to about 0° C., about −140° C. to about −25° C., about −140° C. to about −50° C., about −140° C. to about −100° C., about −140° C. to about −120° C., about −120° C. to about 120° C., about −120° C. to about 110° C., about −120° C. to about 100° C., about −120° C. to about 50° C., about −120° C. to about 25° C., about −120° C. to about 0° C., about −120° C. to about −25° C., about −120° C. to about −50° C., about −120° C. to about −100° C., about −100° C. to about 120° C., about −100° C. to about 110° C., about −100° C. to about 100° C., about −100° C. to about 50° C., about −100° C. to about 25° C., about −100° C. to about 0° C., about −100° C. to about −25° C., about −100° C. to about −50° C., about −75° C. to about 120° C., about −75° C. to about 110° C., about −75° C. to about 100° C., about −75° C. to about 50° C., about −75° C. to about 25° C., about −75° C. to about 0° C., about −75° C. to about −25° C., about −50° C. to about 120° C., about −50° C. to about 110° C., about −50° C. to about 100° C., about −50° C. to about 50° C., about −50° C. to about 25° C., about −50° C. to about 0° C., about −25° C. to about 120° C., about −25° C. to about 110° C., about −25° C. to about 100° C., about −25° C. to about 50° C., about −25° C. to about 25° C., about 0° C. to about 120° C., about 0° C. to about 110° C., about 0° C. to about 100° C., about 0° C. to about 50° C., about 0° C. to about 25° C., about 25° C. to about 120° C., about 25° C. to about 110° C., about 25° C. to about 100° C., about 25° C. to about 50° C., about 50° C. to about 120° C., about 50° C. to about 110° C., about 50° C. to about 100° C., about 100° C. to about 120° C., about 100° C. to about 110° C., or about 110° C. to about 120° C. In some embodiments, the compositions provided herein may be suitable as a working fluid at a temperature of from −135° C. to about 110° C. In some embodiments, the compositions provided herein may be suitable as a working fluid at a temperature of from −95° C. to about 100° C. In some embodiments, the compositions provided herein may be suitable as a working fluid at a temperature of from −70° C. to about 60° C.

In some embodiments, the compositions provided herein are useful in mobile heat transfer systems, including refrigeration, air conditioning, or heat pump systems or apparatus. In some embodiments, the compositions are useful in stationary heat transfer systems, including refrigeration, air conditioning, or heat pump systems or apparatus.

As used herein, mobile refrigeration, air conditioning, or heat pump systems refers to any refrigeration, air conditioner, or heat pump apparatus incorporated into a transportation unit for the road, rail, sea or air. Mobile air conditioning or heat pumps systems may be used in automobiles, trucks, railcars or other transportation systems. Mobile refrigeration may include transport refrigeration in trucks, airplanes, or rail cars. In addition, apparatus which are meant to provide refrigeration for a system independent of any moving carrier, known as “intermodal” systems, are including in the present inventions. Such intermodal systems include “containers” (combined sea/land transport) as well as “swap bodies” (combined road and rail transport).

As used herein, stationary air conditioning or heat pump systems are systems that are fixed in place during operation. A stationary air conditioning or heat pump system may be associated within or attached to buildings of any variety. These stationary applications may be stationary air conditioning and heat pumps, including but not limited to chillers, heat pumps, including residential and high temperature heat pumps, residential, commercial or industrial air conditioning systems, and including window, ductless, ducted, packaged terminal, and those exterior but connected to the building such as rooftop systems.

Stationary heat transfer may refer to systems for cooling electronic devices, such as immersion cooling systems, submersion cooling systems, phase change cooling systems, data-center cooling systems or simply liquid cooling systems.

In some embodiments, a method is provided for using the present compositions as a heat transfer fluid. The method comprises transporting said composition from a heat source to a heat sink.

In some embodiments, a method is provided for producing cooling comprising evaporating any of the present compounds or compositions in the vicinity of a body to be cooled, and thereafter condensing said composition.

In some embodiments, a method is provided for producing heating comprising condensing any of the present compositions in the vicinity of a body to be heated, and thereafter evaporating said compositions.

In some embodiments, the composition is for use in heat transfer, wherein the working fluid is a heat transfer component.

In some embodiments, the compositions of the invention are for use in refrigeration or air conditioning.

In some embodiments, compositions of the present invention may be useful for reducing or eliminating the flammability of flammable refrigerants provided herein. In some embodiments, the present application provided herein is a method for reducing the flammability of a flammable refrigerant comprising adding a composition comprising a composition as disclosed herein to a flammable refrigerant.

The compositions provided herein may be useful as a replacement for a currently used (“incumbent”) refrigerant or oil. As used herein, the term “incumbent refrigerant” or “incumbent oil” shall be understood to mean the refrigerant or oil for which the heat transfer system was designed to operate, or the refrigerant or oil that is resident in the heat transfer system. In some embodiments, the compositions provided herein may be useful as a replacement for an incumbent refrigerant selected from perfluorocarbon, a perfluoropolyether, a silicon oil, a hydrocarbon oil, and an ethylene glycol aqueous solution. In some embodiments, the incumbent refrigerant is methyl perfluoroheptene ether (MPHE).

In some embodiments, the replacement composition (i.e., the composition provided herein) increases the operating temperature range of the refrigeration or heat pump system compared to the heat transfer fluid (e.g., increases the operating temperature to a temperature of from about −140° C. to about 120° C., as described herein).

Often replacement refrigerants are most useful if capable of being used in the original refrigeration equipment designed for a different refrigerant, e.g., with minimal to no system modifications. In many applications, some embodiments of the disclosed compositions are useful as refrigerants and provide at least comparable cooling performance (meaning cooling capacity) as the refrigerant for which a replacement is being sought.

In some embodiments, the high temperature heat pump comprises a condenser operating at a temperature greater than about 50° C. In some embodiments, the high temperature heat pump comprises a condenser operating at a temperature greater than about 100° C. In some embodiments, the high temperature heat pump comprises a condenser operating at a temperature greater than about 120° C. In some embodiments, the high temperature heat pump comprises a condenser operating at a temperature greater than about 150° C.

In some embodiments, the present application provides a method for improving energy efficiency of a heat transfer system or apparatus comprising an incumbent refrigerant, comprising substantially replacing the incumbent refrigerant with a replacement refrigerant composition provided herein, thereby improving the efficiency of the heat transfer system. In some embodiments, the heat transfer system is a chiller system or chiller apparatus provided herein.

In some embodiments is provided a method for operating a heat transfer system or for transferring heat that is designed to operate with an incumbent refrigerant by charging an empty system with a composition of the present invention, or by substantially replacing said incumbent refrigerant with a composition of the present invention.

As used herein, the term “substantially replacing” shall be understood to mean allowing the incumbent refrigerant to drain from the system, or pumping the incumbent refrigerant from the system, and then charging the system with a composition of the present invention. The system may be flushed with one or more quantities of the replacement refrigerant before being charged. It shall be understood that in some embodiments, some small quantity of the incumbent refrigerant may be present in the system after the system has been charged with the composition of the present invention.

In another embodiment is provided a method for recharging a heat transfer system that contains an incumbent refrigerant and a lubricant, said method comprising substantially removing the incumbent refrigerant from the heat transfer system while retaining a substantial portion of the lubricant in said system and introducing one of the present compositions to the heat transfer system. In some embodiments, the lubricant in the system is partially replaced.

In some embodiments, the compositions of the present invention may be used to top-off a refrigerant charge in a chiller. For example, if a chiller using an incumbent refrigerant has diminished performance due to leakage of refrigerant, the compositions as disclosed herein may be added to bring performance back up to specification.

In some embodiments, a heat exchange system containing any the presently disclosed compositions is provided, wherein said system is selected from the group consisting of air conditioners, freezers, refrigerators, heat pumps, water chillers, flooded evaporator chillers, direct expansion chillers, walk-in coolers, heat pumps, mobile refrigerators, mobile air conditioning units, and systems having combinations thereof. Additionally, the compositions provided herein may be useful in secondary loop systems wherein these compositions serve as the primary refrigerant thus providing cooling to a secondary heat transfer fluid that thereby cools a remote location.

In some embodiments, the systems described herein may operate more efficiently if the heat exchangers are operated in counter-current mode or cross-current mode with counter-current tendency. Counter-current tendency means that the closer the heat exchanger can get to counter-current mode the more efficient the heat transfer. Thus, air conditioning heat exchangers, in particular evaporators, are designed to provide some aspect of counter-current tendency.

In some embodiments, the present application provides an air conditioning or heat pump system, wherein said system includes one or more heat exchangers (either evaporators, condensers or both) that operate in counter-current mode or cross-current mode with counter-current tendency.

In some embodiments, provided herein is a refrigeration system wherein said system includes one or more heat exchangers (either evaporators, condensers or both) that operate in counter-current mode or cross-current mode with counter-current tendency.

In some embodiments, the refrigeration, air conditioning or heat pump system is a stationary refrigeration, air conditioning or heat pump system. In some embodiments the refrigeration, air conditioning, or heat pump system is a mobile refrigeration, air conditioning or heat pump system.

Additionally, in some embodiments, the disclosed compositions may function as primary refrigerants in secondary loop systems that provide cooling to remote locations by use of a secondary heat transfer fluid, which may comprise water, an aqueous salt solution (e.g., calcium chloride), a glycol, carbon dioxide, or a fluorinated hydrocarbon fluid (meaning an HFC, HCFC, hydrofluoroolefin (“HFO”), hydrochlorofluoroolefin (“HCFO”), chlorofluoroolefin (“CFO”), or perfluorocarbon (“PFC”). In this case, the secondary heat transfer fluid is the body to be cooled as it is adjacent to the evaporator and is cooled before moving to a second remote body to be cooled. In some embodiments, the disclosed compositions may function as the secondary heat transfer fluid, thus transferring or providing cooling (or heating) to the remote location.

In some embodiments, the compositions provided herein further comprise one or more additives selected from the group consisting of lubricants, dyes (including UV dyes), solubilizing agents, compatibilizers, tracers, anti-wear agents, extreme pressure agents, polymerization inhibitors, metal surface energy reducers, metal surface deactivators, foam control agents, viscosity index improvers, pour point depressants, detergents, viscosity adjusters, and mixtures thereof (e.g., a composition comprising methyl perfluoroheptene ether; a second component selected from the group consisting of one or more antioxidants and one or more acid scavengers; and one or more additives). Indeed, many of the optional additives described herein fit into one or more of these categories and may have qualities that lend themselves to achieve one or more performance characteristic.

In some embodiments, one or more additives (i.e., additive components) are present in small amounts relative to the overall composition. In some embodiments, the amount of additive(s) concentration in the disclosed compositions is from less than about 0.1 weight percent to as much as about 5 weight percent of the total composition. In some embodiments of the present invention, the additives are present in the disclosed compositions in an amount between about 0.1 weight percent to about 5 weight percent of the total composition or in an amount between about 0.1 weight percent to about 3.5 weight percent. The additive component(s) selected for the composition provided here can be selected on the basis of the utility and/or individual equipment components or the system requirements.

In some embodiments, the lubricant is selected from the group consisting of mineral oil, an alkylbenzene, a polyol ester, a polyalkylene glycol, a polyvinyl ether, a polycarbonate, a silicone, a silicate ester, a phosphate ester, a paraffin, a naphthene, a polyalpha-olefin, and combinations thereof.

The lubricants as disclosed herein may be commercially available lubricants. For example, the lubricant may be paraffinic mineral oil, sold by BVA Oils as BVM 100 N, naphthenic mineral oils sold by Crompton Co. under the trademarks Suniso® 1GS, Suniso® 3GS and Suniso® 5GS, naphthenic mineral oil sold by Pennzoil under the trademark Sontex® 372LT, naphthenic mineral oil sold by Calumet Lubricants under the trademark Calumet® RO-30, linear alkylbenzenes sold by Shrieve Chemicals under the trademarks Zerol® 75, Zerol® 150 and Zerol® 500 and branched alkylbenzene sold by Nippon Oil as HAB 22, polyol esters (POEs) sold under the trademark Castrol® 100 by Castrol, United Kingdom, polyalkylene glycols (PAGs) such as RL-488A from Dow (Dow Chemical, Midland, Mich.), and mixtures thereof.

Notwithstanding the weight ratios for compositions disclosed herein, it is understood that in some heat transfer systems, while the composition is being used, it may acquire additional lubricant from one or more equipment components of such heat transfer system. For example, in some refrigeration, air conditioning and heat pump systems, lubricants may be charged in the compressor and/or the compressor lubricant sump. Such lubricant would be in addition to any lubricant additive present in the refrigerant in such a system. In use, the refrigerant when in the compressor may pick up an amount of the equipment lubricant to change the refrigerant-lubricant composition from the starting ratio.

In some embodiments, the compositions provided herein further comprise at least one dye. The dye may be at least one ultra-violet (UV) dye. As used herein, “ultra-violet” dye is defined as a UV fluorescent or phosphorescent composition that absorbs light in the ultra-violet or “near” ultra-violet region of the electromagnetic spectrum. The fluorescence produced by the UV fluorescent dye under illumination by a UV light that emits at least some radiation with a wavelength in the range of from 10 nanometers to about 775 nanometers may be detected.

UV dye is a useful component for detecting leaks of the composition by permitting one to observe the fluorescence of the dye at or in the vicinity of a leak point in an apparatus (e.g., refrigeration unit, air-conditioner or heat pump). The UV emission, e.g., fluorescence from the dye may be observed under an ultra-violet light. Therefore, if a composition containing such a UV dye is leaking from a given point in an apparatus, the fluorescence can be detected at the leak point, or in the vicinity of the leak point.

In some embodiments, the UV dye may be a fluorescent dye. In some embodiments, the fluorescent dye is selected from the group consisting of naphthalimides, perylenes, coumarins, anthracenes, phenanthracenes, xanthenes, thioxanthenes, naphthoxanthenes, fluoresceins, and derivatives of said dye, and combinations thereof.

In some embodiments, the compositions provided herein further comprise at least one solubilizing agent, e.g., selected to improve the solubility of one or more dyes in the compositions provided herein. In some embodiments, the weight ratio of dye to solubilizing agent ranges from about 99:1 to about 1:1. The solubilizing agents include at least one compound selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers, and 1,1,1-trifluoroalkanes and mixtures thereof.

In some embodiments, the compositions provided herein further comprise at least one compatibilizer, e.g., to improve the compatibility of one or more lubricants with the compositions provided herein. The compatibilizer may be selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers, 1,1,1-trifluoroalkanes, and mixtures thereof, meaning mixtures of any of the compatibilizers disclosed in this paragraph.

The solubilizing agent and/or compatibilizer may be selected from the group consisting of hydrocarbon ethers consisting of the ethers containing only carbon, hydrogen and oxygen, such as dimethyl ether (DME) and mixtures thereof, meaning mixtures of any of the hydrocarbon ethers disclosed in this paragraph.

The compatibilizer may be linear or cyclic aliphatic or aromatic hydrocarbon compatibilizer containing from 3 to 15 carbon atoms. The compatibilizer may be at least one hydrocarbon, which may be selected from the group consisting of at least propanes, including propylene and propane, butanes, including n-butane and isobutene, pentanes, including n-pentane, isopentane, neopentane and cyclopentane, hexanes, octanes, nonane, and decanes, among others. Commercially available hydrocarbon compatibilizers include but are not limited to those from Exxon Chemical (USA) sold under the trademarks Isopar® H, a mixture of undecane (C₁₁) and dodecane (C₁₂) (a high purity C₁₁ to C₁₂ iso-paraffinic), Aromatic 150 (a C₉ to C₁₁ aromatic) (Aromatic 200 (a C₉ to C₁₅ aromatic) and Naptha 140 (a mixture of C₅ to C₁₁ paraffins, naphthenes and aromatic hydrocarbons) and mixtures thereof, meaning mixtures of any of the hydrocarbons disclosed in this paragraph.

The compatibilizer may alternatively be at least one polymeric compatibilizer. The polymeric compatibilizer may be a random copolymer of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ are independently selected from the group consisting of H and C₁-C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups and mixtures thereof. Examples of such polymeric compatibilizers include those commercially available from E. I. du Pont de Nemours and Company, (Wilmington, Del., 19898, USA) under the trademark Zonyl® PHS. Zonyl® PHS is a random copolymer made by polymerizing 40 weight percent CH₂═C(CH₃)CO₂CH₂CH₂(CF₂CF₂)ₘF (also referred to as Zonyl® fluoromethacrylate or ZFM) wherein m is from 1 to 12, primarily 2 to 8, and 60 weight percent lauryl methacrylate (CH₂═C(CH₃)CO₂(CH₂)₁₁CH₃, also referred to as LMA).

In some embodiments, the compatibilizer component contains from about 0.01 to 30 weight percent (based on total amount of compatibilizer) of an additive which reduces the surface energy of metallic copper, aluminum, steel, or other metals and metal alloys thereof found in heat exchangers in a way that reduces the adhesion of lubricants to the metal. Examples of metal surface energy reducing additives include those commercially available from DuPont under the trademarks Zonyl® FSA, Zonyl® FSP, and Zonyl® FSJ.

In some embodiments, the compositions provided herein further comprise a metal surface deactivator. In some embodiments, the metal surface deactivator is selected from the group consisting of areoxalyl bis (benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof, meaning mixtures of any of the metal surface deactivators disclosed in this paragraph.

In some embodiments, the composition provided herein further comprise a tracer. The tracer may be two or more tracer compounds from the same class of compounds or from different classes of compounds. In some embodiments, the tracer is present in the compositions at a total concentration of about 50 parts per million by weight (ppm) to about 1000 ppm, based on the weight of the total composition. In some embodiments, the tracer is present at a total concentration of about 50 ppm to about 500 ppm. Alternatively, the tracer is present at a total concentration of about 100 ppm to about 300 ppm.

The tracer may be selected from the group consisting of hydrofluorocarbons (HFCs), deuterated hydrofluorocarbons, perfluorocarbons (e.g., an additional perfluorocarbon), fluoroethers, brominated compounds, iodinated compounds, alcohols, aldehydes and ketones, nitrous oxide, and combinations thereof. In some embodiments, the tracer is selected from the group consisting of trifluoromethane (HFC-23), fluoroethane (HFC-161), 1,1,1,2,2,3,3-heptafluoropropane (HFC-227ca), 1,1,1,2,2,3-hexafluoropropane (HFC-236cb), 1,1,1,2,3,3-hexafluoropropane (HFC-236ea), 1,1,1,2,2-pentafluoropropane (HFC-245cb), 1,1,2,2-tetrafluoropropane (HFC-254cb), 1,1,1,2-tetrafluoropropane (HFC-254eb), 1,1,1-trifluoropropane (HFC-263fb), 2,2-difluoropropane (HFC-272ca), 2-fluoropropane (HFC-281ea), 1-fluoropropane (HFC-281fa), 1,1,1,2,2,3,3,4-nonafluorobutane (HFC-329p), 1,1,1-trifluoro-2-methylpropane (HFC-329mmz), 1,1,1,2,2,4,4,4-octafluorobutane (HFC-338mf), 1,1,2,2,3,3,4,4-octafluorobutane (HFC-338pcc), 1,1,1,2,2,3,3-heptafluorobutane (HFC-347s), hexafluoroethane (perfluoroethane, PFC-116), perfluoro-cyclopropane (PFC-C216), perfluoropropane (PFC-218), perfluoro-cyclobutane (PFC-C318), perfluorobutane (PFC-31-10mc), perfluoro-2-methylpropane (CF₃CF(CF₃)₂), perfluoro-1,3-dimethylcyclobutane (PFC-051-12mycm), trans-perfluoro-2,3-dimethylcyclobutane (PFC-C51-12mym, trans), cis-perfluoro-2,3-dimethylcyclobutane (PFC-C51-12mym, cis), perfluoromethylcyclopentane, perfluoromethylcyclohexane, perfluorodimethylcyclohexane (ortho, meta, or para), perfluoroethylcyclohexane, perfluoroindan, perfluorotrimethylcyclohexane and isomers thereof, perfluoroisopropylcyclohexane, cis-perfluorodecalin, trans-perfluorodecalin, cis- or trans-perfluoromethyldecalin and mixtures thereof. In some embodiments, the tracer is a blend containing two or more hydrofluorocarbons, or one hydrofluorocarbon in combination with one or more perfluorocarbons.

The tracer may be added to the compositions of the present invention in predetermined quantities to allow detection of any dilution, contamination or other alteration of the composition.

The additive which may be used with the compositions of the present invention may alternatively be a perfluoropolyether as described in US 2007-0284555, the disclosure of which is incorporated herein by reference in its entirety.

It will be recognized that certain of the additives referenced above have been identified as potential refrigerants. However, in accordance with this invention, when these additives are used, they are not present at an amount that would affect the novel and basic characteristics of the refrigerant mixtures of this invention.

In some embodiments, the refrigerant compositions disclosed herein may be prepared by any convenient method to combine the desired amounts of the individual components as is standard in the art. A preferred method is to weigh the desired component amounts and thereafter combine the components in an appropriate vessel. Agitation may be used, if desired.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1

### Methyl Perfluoroheptene Ether Compositions

The following stabilized compositions were prepared for analysis in degradation studies. The compositions were prepared from MPHE and the stabilizers shown in Table 1. HQMME=hydroquinone monomethyl ether. BHT=butylated hydroxy toluene.

TABLE 1

| Composition | Stabilizer | Concentration (ppm) |
|---|---|---|
| 2 | HQMME | 140 |
| 3 | BHT | 500 |
| 4 | HQMME + 1,2-epoxybutane | 140 ppm HQMME; 500 |
| | | ppm 1,2-epoxybutane |
| 5 | BHT + 1,2-epoxybutane | 500 ppm, BHT; 500 |
| | | ppm 1,2-epoxybutane |
| 6 | BHT + 1,3-dioxolane | 500 ppm BHT; 500 |
| | | ppm 1,3-dioxolane |
| 7 | HQMME + 1,3-dioxolane | 140 ppm HQMME; 500 |
| | | ppm 1,3-dioxolane |
| 8 | BHT + 1,2-epoxybutane | 450 ppm BHT; 500 |
| | | ppm 1,2-epoxybutane |

### Example 2

### Total Acid Number (TAN) Analysis

The total acid number (TAN) of representative stabilized compositions was analyzed according to the following procedures. A known amount of MPHE (typically 2 g-5 g) was added directly to 100 mL of the TAN solvent mixture (50 wt % toluene, 49.5 wt % propan-2-ol, and 0.5 wt % water), and titrated with 0.1 N KOH to the potentiometric inflection point (in mL). To account for acidity sourced from the TAN solvent, experiments were repeated with just 100 mL of the TAN solvent as a control (no sample added) and titrated to same inflection point (in mL). The baseline endpoint was subtracted from the sample endpoint, to determine the true titration volume from the MPHE sample. The total acid number was calculated according to Equation 1, where V_{S}=volume of the sample titration; V_{B}=volume of blank titration; mmol/mL=molarity of titrant (0.1N); 56 mg/mmol=MW of KOH; M_{MPHE}=mass of MPHE analyzed, in grams (g). The MPHE product acidity specification is ≤0.1 mg KOH/g.

TAN (mg KOH/g)=((V_{S}−V_{B})*0.1 mmol/mL*56 mg/mmol)/M_{MPHE} Equation 1.

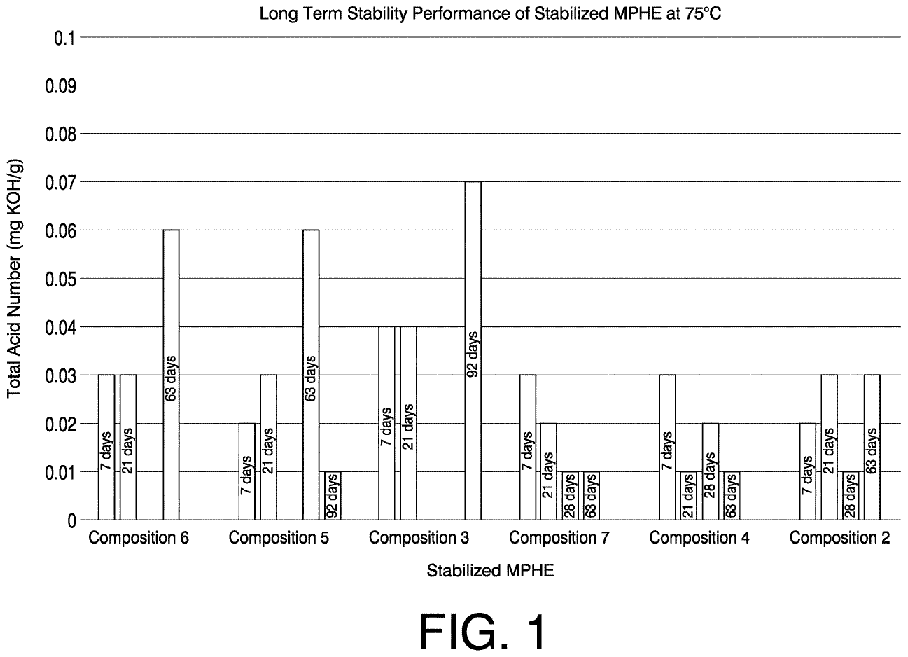

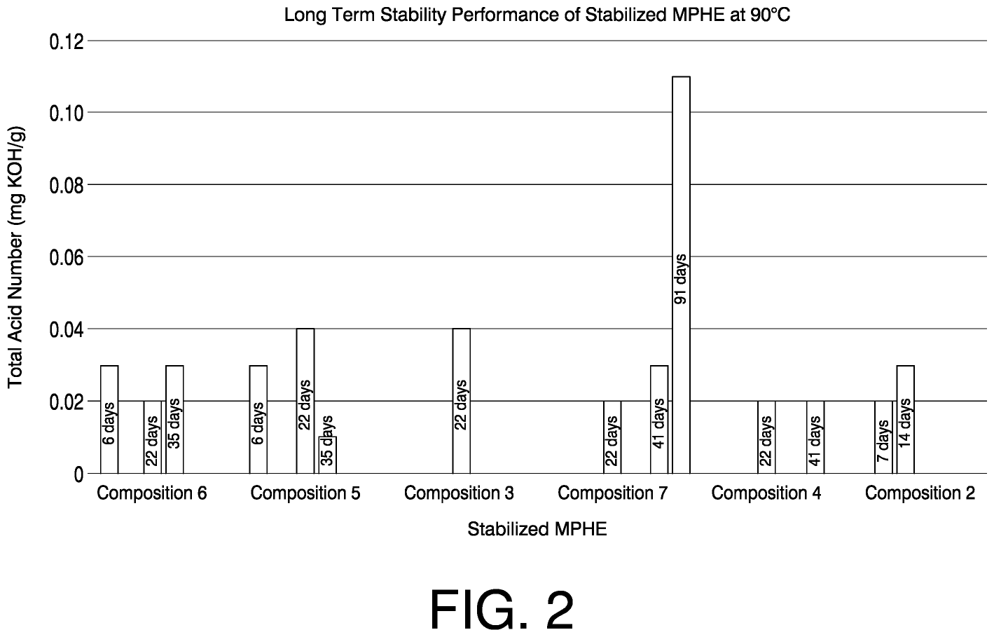

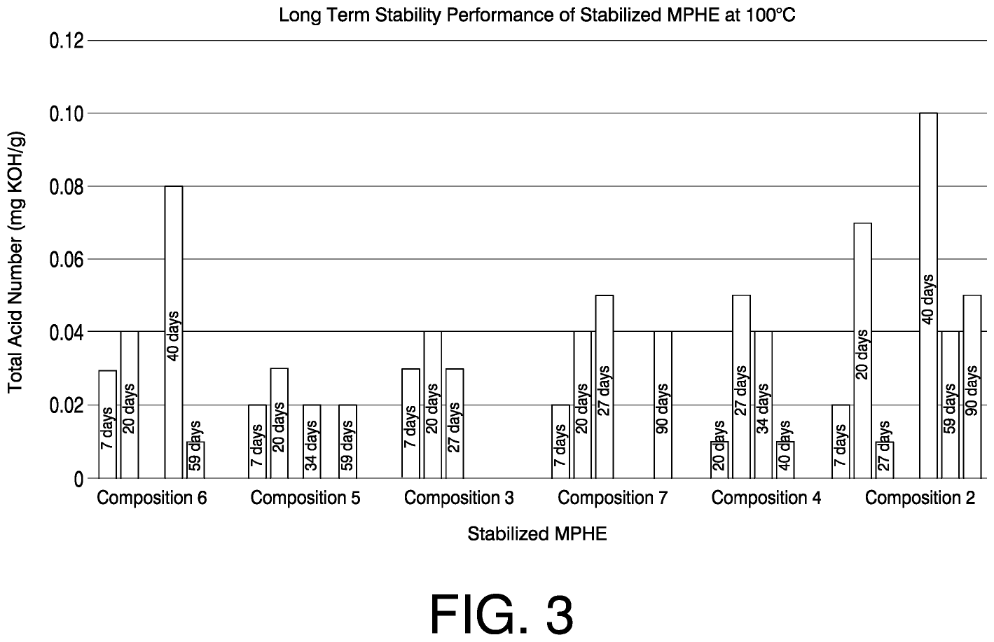

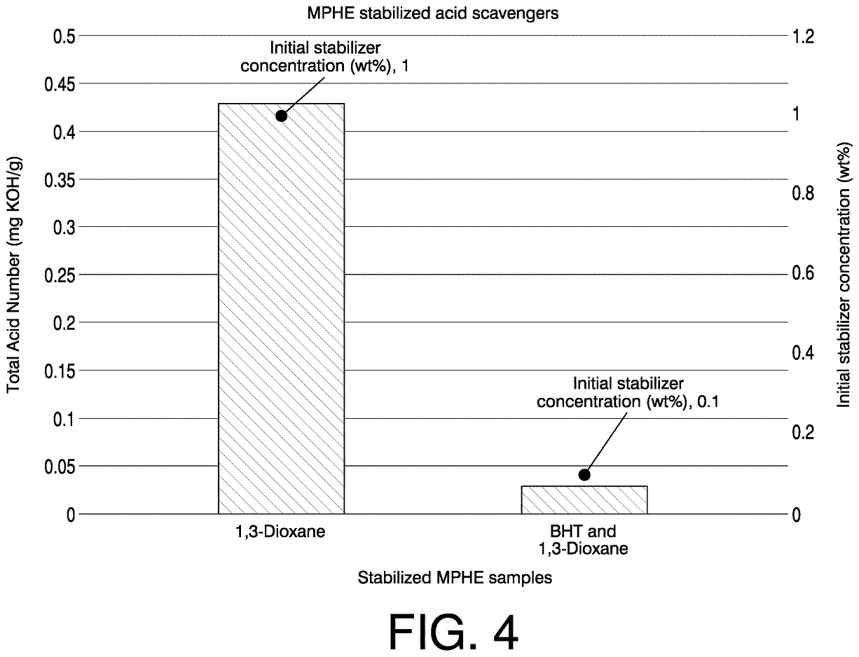

The effectiveness of representative stabilized compositions analyzed as Total Acid Number (TAN) vs. unstabilized MPHE is shown in FIGS. 1-4 and below in Table 2.

TABLE 2

| | | Total Acid | | Total Acid |
|---|---|---|---|---|
| | | Number | | Number |
| | Temp | (mg | Temp | (mg |
| Composition | (° C.)/Duration | KOH/g) | (° C.)/Duration | KOH/g) |
| 2 | 100° C./40 days | <0.1 | 75° C./90 days | <0.1 |
| 3 | 100° C./59 days | <0.1 | 75° C./90 days | <0.1 |
| 4 | 100° C./40 days | <0.1 | 75° C./63 days | <0.1 |
| 6 | 100° C./59 days | <0.1 | 75° C./90 days | <0.1 |
| 7 | 100° C./40 days | <0.1 | 75° C./63 days | <0.1 |
| 8 | 100° C./59 days | <0.1 | 75° C./90 days | <0.1 |

As shown in FIGS. 1-4 and Table 2, the stabilized compositions effectively mitigated formation of degradation byproducts (e.g., acidic byproducts) effectively stabilized both liquid and vapor phase of the MPHE. Hence, Compositions 1-6 would may useful as working fluids in effectively preventing metal corrosion of chiller components during normal operation.

The stabilized MPHE exhibited no closed cup flashpoint, and NVR (non-volatile residue) was below 1 ppm.

### Example 3

### Methyl Perfluoroheptene Ether Compositions

The following stabilized compositions were prepared for analysis in degradation studies. The compositions were prepared from MPHE and the stabilizers shown in Table 3. 2tB6M=2-tert-butyl-methylphenol. 2tB5M=2-tert-butyl-5-methylphenol. 2tB4E=2-tert-butyl-4-ethylphenol.

TABLE 3

| Composition | Stabilizer | Concentration (ppm) |
|---|---|---|
| 9 | 2-tert-butyl-6-methylphenol | 339 ppm |
| 10 | 2-tert-butyl-5-methylphenol | 275 ppm |
| 11 | 2-tert-butyl-4-ethylphenol | 292 ppm |
| 12 | 2-tert-butyl-6-methylphenol + | 295 ppm 2tB6M; 400 |
| | 1,2-epoxybutane | ppm 1,2-epoxybutane |
| 13 | 2-tert-butyl-6-methylphenol + | 295 ppm 2tB6M; 400 |
| | nitromethane | ppm nitromethane |
| 14 | 2-tert-butyl-6-methylphenol | 110 ppm |

### Example 4

### Total Acid Number (TAN) Analysis

The total acid number (TAN) of representative stabilized compositions listed in table 3 was analyzed according to procedures described in example 2. The effectiveness of representative stabilized compositions 9-14 analyzed as Total Acid Number (TAN) is shown below in Table 4.

TABLE 4

| | Temp | Total Acid Number |
|---|---|---|
| Composition | (°C.)/Duration | (mg KOH/g) |
| 9 | 90° C./90 days | <0.1 |
| 10 | 90° C./90 days | <0.1 |
| 11 | 90° C./90 days | <0.1 |
| 12 | 90° C./42 days | <0.1 |
| 13 | 90° C./42 days | <0.1 |
| 14 | 90° C./29 days | <0.1 |

### Comparative Example 1

A comparative TAN analysis was performed according to the procedures described in Example 2, using MPHE compositions containing an initial stabilizer concentration of (1) 1 wt % 1,3-dioxane; or (2) 0.1 wt % of a mixture of BHT and 1,3-dioxolane. As shown in Table 5 and FIG. 5, the stabilized composition containing 0.1 wt % BHT and 1,3-dioxolane exhibited a TAN of 0.03 mg KOH/g after 6 days at a temperature of 75° C., which is significantly below MPHE product specification (0.1 mg KOH/g). In contrast, the composition containing 1 wt % 1,3-dioxane exhibited a TAN of 0.43 mg KOH/g.

TABLE 5

| | | Initial stabilizer |
|---|---|---|
| | TAN | concentration |
| Stabilizer | (mg KOH/g) | (wt %) |
| 1,3-Dioxane | 0.43 | 1 |
| BHT and 1,3 Dioxolane | 0.03 | 0.1 |

### Other Embodiments

1. In some embodiments, the present application provides a composition, comprising:
i) methyl perfluoroheptene ether; and
ii) a second component selected from the group consisting of butylated hydroxy toluene, hydroquinone monomethyl ether, 2-tert-butyl-6-methylphenol, 2-tert-butyl-5-methylphenol, 2-tert-butyl-4-ethylphenol, 1,3-dioxolane, 1,2-epoxybutane and nitromethane, or any mixture thereof.

2. The composition of embodiment 1, wherein the second component is present in the composition in an amount effective to maintain a total acid number of the composition at about 0.1 mg KOH/g, or less.

3. The composition of embodiment 1 or 2, wherein the methyl perfluoroheptene ether comprises a mixture of about 50 weight percent 5-methoxy perfluoro-3-heptene, about 20 weight percent 3-methoxy perfluoro-3-heptene, about 20 weight percent 4-methoxy perfluoro-2-heptene, and about 8 weight percent 4-methoxy perfluoro-3-heptene.

4. The composition of any one of embodiments 1 to 3, wherein the second component is selected from the group consisting of butylated hydroxy toluene and hydroquinone monomethyl ether.

5. The composition of any one of embodiments 1 to 4, wherein the composition comprises about 100 ppm to about 550 ppm of the second component.

6. The composition of any one of embodiments 1 to 3 and 5, wherein the second component is selected from the group consisting of:
butylated hydroxy toluene;
hydroquinone monomethyl ether;
2-tert-butyl-6-methylphenol;
2-tert-butyl-5-methylphenol;
2-tert-butyl-4-ethylphenol;
a mixture of butylated hydroxy toluene and 1,2-epoxybutane;
a mixture of hydroquinone monomethyl ether and 1,3-dioxolane;
a mixture of hydroquinone monomethyl ether and 1,2-epoxybutane;
a mixture of butylated hydroxy toluene and 1,3-dioxolane;
a mixture of 2-tert-butyl-6-methylphenol and 1,2-epoxybutane; and
a mixture of 2-tert-butyl-6-methylphenol and nitromethane.

7. The composition of any one of embodiments 1 to 6, wherein the composition comprises about 100 ppm to about 1100 ppm of the second component.

8. The composition of any one of embodiments 1 to 3 and 5 to 7, wherein the composition comprises methyl perfluoroheptene ether; and
about 450 ppm to about 550 ppm butylated hydroxy toluene; or
about 100 ppm to about 200 ppm hydroquinone monomethyl ether; or
about 400 ppm to about 550 ppm butylated hydroxy toluene and about 450 ppm to about 550 ppm 1,2-epoxybutane; or
about 100 ppm to about 200 ppm hydroquinone monomethyl ether and about 450 ppm to about 550 ppm 1,3-dioxolane; or
about 100 ppm to about 200 ppm hydroquinone monomethyl ether and about 450 ppm to about 550 ppm 1,2-epoxybutane; or
about 450 ppm to about 550 ppm butylated hydroxy toluene and about 450 ppm to about 550 ppm 1,3-dioxolane; or
about 50 to about 500 ppm 2-tert-butyl-6-methylphenol; or
about 50 to about 500 ppm 2-tert-butyl-5-methylphenol; or
about 50 to about 500 ppm 2-tert-butyl-4-ethylphenol; or
about 50 to about 500 ppm 2-tert-butyl-6-methylphenol and about 200 to about 600 ppm 1,2-epoxybutane; or
about 50 to about 500 ppm 2-tert-butyl-6-methylphenol and about 200 to about 600 ppm nitromethane; or
about 300 ppm 2-tert-butyl-6-methylphenol; or
about 300 ppm 2-tert-butyl-5-methylphenol; or
about 300 ppm 2-tert-butyl-4-ethylphenol; or
about 300 ppm 2-tert-butyl-6-methylphenol and about 400 ppm 1,2-epoxybutane; or
about 300 ppm 2-tert-butyl-6-methylphenol and about 400 ppm nitromethane.

9. The composition of any one of embodiments 1 to 3 and 5 to 8, wherein the composition comprises methyl perfluoroheptene ether; and
about 140 ppm hydroquinone monomethyl ether; or
about 500 ppm butylated hydroxy toluene; or
about 140 ppm hydroquinone monomethyl ether and about 500 ppm 1,2-epoxybutane; or
about 500 ppm butylated hydroxy toluene and about 500 ppm 1,2-epoxybutane; or
about 500 ppm butylated hydroxy toluene and about 500 ppm 1,3-dioxolane
about 140 ppm hydroquinone monomethyl ether and about 500 ppm 1,3-dioxolane; or
about 450 ppm butylated hydroxy toluene and about 500 ppm 1,2-epoxybutane.

10. In some embodiments, the present application further provides a method of reducing acidic degradation of a working fluid comprising methyl perfluoroheptene ether, comprising mixing the working fluid with a second component selected from the group consisting of one or more antioxidants and one or more acid scavengers, or any mixture thereof, thereby forming a stabilized working fluid.

11. The method of embodiment 10, wherein the second component selected from the group consisting of one or more antioxidants.

12. The method of embodiment 10 or 11, wherein the second component is selected from the group consisting of of butylated hydroxy toluene, hydroquinone monomethyl ether, 2-tert-butyl-6-methylphenol, 2-tert-butyl-5-methylphenol and 2-tert-butyl-4-ethylphenol, or a mixture thereof.

13. The method of embodiment 10 or 11, wherein the second component is selected from the group consisting of:
butylated hydroxy toluene;
2-tert-butyl-6-methylphenol;
2-tert-butyl-5-methylphenol;
2-tert-butyl-4-ethylphenol;
hydroquinone monomethyl ether;
a mixture of butylated hydroxy toluene and 1,2-epoxybutane;
a mixture of hydroquinone monomethyl ether and 1,3-dioxolane;
a mixture of hydroquinone monomethyl ether and 1,2-epoxybutane;
a mixture of 2-tert-butyl-6-methylphenol and 1,2-epoxybutane;
a mixture of 2-tert-butyl-6-methylphenol and nitromethane; and
a mixture of butylated hydroxy toluene and 1,3-dioxolane.

14. In some embodiments, the present application further provides a process for dissolving a solute, comprising contacting and mixing said solute with a sufficient quantity of the composition of any one of embodiments 1 to 9.

15. In some embodiments, the present application further provides a process of cleaning a surface, comprising contacting the composition of any one of embodiments 1 to 9 with said surface.

16. In some embodiments, the present application further provides a process for removing at least a portion of water from the surface of a wetted substrate, comprising contacting the substrate with the composition of any one of embodiments 1 to 9, and then removing the substrate from contact with the composition.

17. The process of embodiment 16, wherein composition further comprises at least one surfactant suitable for dewatering or drying the substrate.

18. In some embodiments, the present application further provides a process of depositing a fluorolubricant on a surface, comprising:
a) combining a fluorolubricant and a solvent to form a lubricant-solvent combination, wherein the solvent comprises a composition of any one of embodiments 1 to 9;
b) contacting the lubricant-solvent combination with the surface; and
c) evaporating the solvent from the surface to form a fluorolubricant coating on the surface.

19. In some embodiments, the present application further provides a process for producing cooling, comprising condensing the composition of any one of embodiments 1 to 9 and thereafter evaporating said composition in the vicinity of a body to be cooled.

20. In some embodiments, the present application further provides a process for producing heating, comprising evaporating the composition of any one of embodiments 1 to 9 and thereafter condensing said composition in the vicinity of a body to be heated.

21. In some embodiments, the present application further provides a method for producing cooling, comprising circulating a heat transfer fluid comprising a composition of any one of embodiments 1 to 9 in the vicinity of a body to be cooled, wherein the heat transfer fluid is a working fluid that removes heat from, adds heat to, or maintains temperature of the vicinity of the body to be cooled.

22. In some embodiments, the present application further provides a method of replacing a heat transfer fluid in a cooling fluid distribution unit, a refrigeration system, or a heat pump system, comprising providing the composition of any one of embodiments 1 to 9 as replacement for said heat transfer fluid.

23. The embodiment of embodiment 22, wherein the refrigeration system or heat pump system comprises a single-phase chiller.

24. The embodiment of embodiment 22 or 23, wherein the chiller is a single-phase semi-conductor chiller.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. A composition, comprising:
i) methyl perfluoroheptene ether; and
ii) a second component selected from the group consisting of butylated hydroxy toluene, hydroquinone monomethyl ether, 2-tert-butyl-6-methylphenol, 2-tert-butyl-5-methylphenol and 2-tert-butyl-4-ethylphenol 1,3-dioxolane, 1,2-epoxybutane and nitromethane, or any mixture thereof.

2. The composition of claim 1, wherein the second component is present in the composition in an amount effective to maintain a total acid number of the composition at about 0.1 mg KOH/g, or less.

3. The composition of claim 2, wherein the methyl perfluoroheptene ether comprises a mixture of about 50 weight percent 5-methoxy perfluoro-3-heptene, about 20 weight percent 3-methoxy perfluoro-3-heptene, about 20 weight percent 4-methoxy perfluoro-2-heptene, and about 8 weight percent 4-methoxy perfluoro-3-heptene.

4. The composition of claim 3, wherein the second component is selected from the group consisting of butylated hydroxy toluene and hydroquinone monomethyl ether.

5. The composition of claim 5, wherein the composition comprises about 100 ppm to about 550 ppm of the second component.

6. The composition of claim 4, wherein the second component is selected from the group consisting of:
butylated hydroxy toluene;
hydroquinone monomethyl ether;
2-tert-butyl-6-methylphenol;
2-tert-butyl-5-methylphenol;
2-tert-butyl-4-ethylphenol;
a mixture of butylated hydroxy toluene and 1,2-epoxybutane;
a mixture of hydroquinone monomethyl ether and 1,3-dioxolane;
a mixture of hydroquinone monomethyl ether and 1,2-epoxybutane;
a mixture of butylated hydroxy toluene and 1,3-dioxolane;
a mixture of 2-tert-butyl-6-methylphenol and 1,2-epoxybutane; and
a mixture of 2-tert-butyl-6-methylphenol and nitromethane.

7. The composition of claim 6, wherein the composition comprises about 100 ppm to about 1100 ppm of the second component.

8. The composition of claim 6, wherein the composition comprises methyl perfluoroheptene ether; and
about 450 ppm to about 550 ppm butylated hydroxy toluene; or
about 100 ppm to about 200 ppm hydroquinone monomethyl ether; or
about 400 ppm to about 550 ppm butylated hydroxy toluene and about 450 ppm to about 550 ppm 1,2-epoxybutane; or
about 100 ppm to about 200 ppm hydroquinone monomethyl ether and about 450 ppm to about 550 ppm 1,3-dioxolane; or
about 100 ppm to about 200 ppm hydroquinone monomethyl ether and about 450 ppm to about 550 ppm 1,2-epoxybutane; or
about 450 ppm to about 550 ppm butylated hydroxy toluene and about 450 ppm to about 550 ppm 1,3-dioxolane; or
about 50 to about 500 ppm 2-tert-butyl-6-methylphenol; or
about 50 to about 500 ppm 2-tert-butyl-5-methylphenol; or
about 50 to about 500 ppm 2-tert-butyl-4-ethylphenol; or
about 50 to about 500 ppm 2-tert-butyl-6-methylphenol and about 200 to about 600 ppm 1,2-epoxybutane; or
about 50 to about 500 ppm 2-tert-butyl-6-methylphenol and about 200 to about 600 ppm nitromethane; or
about 300 ppm 2-tert-butyl-6-methylphenol; or
about 300 ppm 2-tert-butyl-5-methylphenol; or
about 300 ppm 2-tert-butyl-4-ethylphenol; or
about 300 ppm 2-tert-butyl-6-methylphenol and about 400 ppm 1,2-epoxybutane; or
about 300 ppm 2-tert-butyl-6-methylphenol and about 400 ppm nitromethane.

9. The composition of claim 6, wherein the composition comprises methyl perfluoroheptene ether; and
about 140 ppm hydroquinone monomethyl ether; or
about 500 ppm butylated hydroxy toluene; or
about 140 ppm hydroquinone monomethyl ether and about 500 ppm 1,2-epoxybutane; or
about 500 ppm butylated hydroxy toluene and about 500 ppm 1,2-epoxybutane; or
about 500 ppm butylated hydroxy toluene and about 500 ppm 1,3-dioxolane
about 140 ppm hydroquinone monomethyl ether and about 500 ppm 1,3-dioxolane; or
about 450 ppm butylated hydroxy toluene and about 500 ppm 1,2-epoxybutane.

10. A method of reducing acidic degradation of a working fluid comprising methyl perfluoroheptene ether, comprising mixing the working fluid with a second component selected from the group consisting of one or more antioxidants and one or more acid scavengers, or any mixture thereof, thereby forming a stabilized working fluid.

11. The method of claim 10, wherein the second component selected from the group consisting of one or more antioxidants.

12. The method of claim 10, wherein the second component is selected from the group consisting of butylated hydroxy toluene, hydroquinone monomethyl ether, 2-tert-butyl-6-methylphenol, 2-tert-butyl-5-methylphenol and 2-tert-butyl-4-ethylphenol, or a mixture thereof.

13. The method of claim 10, wherein the second component is selected from the group consisting of:
butylated hydroxy toluene;
hydroquinone monomethyl ether;
2-tert-butyl-6-methylphenol;
2-tert-butyl-5-methylphenol;
2-tert-butyl-4-ethylphenol;
a mixture of butylated hydroxy toluene and 1,2-epoxybutane;
a mixture of hydroquinone monomethyl ether and 1,3-dioxolane;
a mixture of hydroquinone monomethyl ether and 1,2-epoxybutane;
a mixture of butylated hydroxy toluene and 1,3-dioxolane;
a mixture of 2-tert-butyl-6-methylphenol and 1,2-epoxybutane; and
a mixture of 2-tert-butyl-6-methylphenol and nitromethane.

14. A process for dissolving a solute, comprising contacting and mixing said solute with a sufficient quantity of the composition of claim 1.

15. A process of cleaning a surface, comprising contacting the composition of claim 1 with said surface.

16. A process for removing at least a portion of water from the surface of a wetted substrate, comprising contacting the substrate with the composition of claim 1, and then removing the substrate from contact with the composition.

17. The process of claim 16, wherein composition further comprises at least one surfactant suitable for dewatering or drying the substrate.

18. A process of depositing a fluorolubricant on a surface, comprising:
a) combining a fluorolubricant and a solvent to form a lubricant-solvent combination, wherein the solvent comprises a composition of claim 1;
b) contacting the lubricant-solvent combination with the surface; and
c) evaporating the solvent from the surface to form a fluorolubricant coating on the surface.

19. A process for producing cooling, comprising condensing the composition of claim 1 and thereafter evaporating said composition in the vicinity of a body to be cooled.

20. A process for producing heating, comprising evaporating the composition of claim 1 and thereafter condensing said composition in the vicinity of a body to be heated.

21. A method for producing cooling, comprising circulating a heat transfer fluid comprising a composition of claim 1 in the vicinity of a body to be cooled, wherein the heat transfer fluid is a working fluid that removes heat from, adds heat to, or maintains temperature of the vicinity of the body to be cooled.

22. A method of replacing a heat transfer fluid in a cooling fluid distribution unit, a refrigeration system, or a heat pump system, comprising providing the composition of claim 1 as replacement for said heat transfer fluid.

23. The method of claim 22, wherein the refrigeration system or heat pump system comprises a single-phase chiller.

24. The method of claim 23, wherein the chiller is a single phase semi-conductor chiller.
